(19) United States
(12) Patent Application Publication
(10) Pub. No.: US 2013/0139561 A1
(43) Pub. Date: Jun. 6, 2013

(54) WIRELESS CONTROLLED ELECTROMECHANICAL CYLINDER

(71) Applicants: Benyamin Parto, Bnei Barak (IL); Tamir Shaharabani, Rishon Lezion (IL); Meir Arbel, Herzeliya (IL)

(72) Inventors: Benyamin Parto, Bnei Barak (IL); Tamir Shaharabani, Rishon Lezion (IL); Meir Arbel, Herzeliya (IL)

(21) Appl. No.: 13/640,496

(22) PCT Filed: Apr. 14, 2011
(86) PCT No.: PCT/IL11/00313

§ 371 Date: Dec. 26, 2012

Related U.S. Application Data
(60) Provisional application No. 61/324,370, filed on Apr. 15, 2010.

(51) Int. Cl. G07C 9/00

(52) U.S. Cl. CPC G07C 9/00182
USPC 70/278.7

(57) ABSTRACT

A mechanical lock device including an electromechanical cylinder, which is retrofittable to a lock device. The electromechanical cylinder is controlled by a wireless enabled communication device transmitting a signal including identifying details of entities authorized to open or close the lock.

### FIELD OF THE INVENTION

This invention relates to electromechanical locks, and in particular electromechanical locks, which are controlled by a wireless-enabled communication device.

### BACKGROUND OF THE INVENTION

Mechanical locks constructed with mechanical cylinders for restricting access to an area or enclosed compartment have been known for many years. The cylinder may contain any of a variety of locking mechanisms, such as cylinder pins.

Due to clear disadventagous involved with mechanical locks, electronic locking mechanisms and electromechanical locks (locks which are partially electrical) have been developed. Some electronic locks require physical contact with certain kinds of physical keys, for example a keypad operated by entering or dialing a combination or a card swiped on a magnetic card reader. Others, which are remotely controlled, require installation of an external component in close proximity to the barrier itself or to the lock, in order to communicate with a remote lock control device and open or close the lock.

Prior art references considered relevant as a background to the invention are listed below and their contents are incorporated herein by reference. Acknowledgement of the references herein is not to be inferred as meaning that these are in any way relevant to the patentability of the invention disclosed herein.

WO0186097 discloses an electromechanical driver controlled by a combination of an intelligent wireless receiver and intelligent wireless transmitter, to form an intelligent lock system. It is understood that the terms “receiver” and “transmitter” are used for the sake of clarity, in order to indicate whether a particular component resides on the wireless remote control device (“transmitter”) or on the lock (“receiver”), as preferably both the remote control device and the lock feature a transceiver. The lock may optionally be incorporated with a mechanical lock, which can either be installed as a complete system, or retrofitted on existing locks with minimal modification.

US2004124967 discloses an electromechanical lock cylinder with integrated electronic control means which upon electronically detectable access rights creates and/or enables a rotating-connection between a lock catch, which operates a lock bolt and manually, or motor operated actuation means. It is provided that the electronic control means of the cylinder lock comprise at least one wireless data signal transmission interface for transmitting data and in particular data for programming the access codes for the access rights.

WO0123694 discloses a locking system comprising a control unit with a memory, a mobile unit with a specific identification number and an electronic locking unit. The control unit being arranged to repeatedly transmit a first radio signal. The mobile unit being arranged to transmit its identification number as a second radio signal in response to receiving the first radio signal. The control unit being further arranged to receive the second radio signal and to disable the electronic locking unit only if the identification number is in the memory.

U.S. Pat. No. 6,967,562 discloses a lock system includes a cylindrical door lock having a latching spindle and an opening spindle which are concentrically oriented, and a wireless communication system to transmit signals indicating the relative positions of the latching spindle and the opening spindle. A door lock assembly can include a lock mechanism for placing the lock assembly into an unlocked state or a locked state, an electrically controlled actuator assembly to control the lock mechanism, a transceiver coupled to the actuator assembly, and a communication device to communicate over a two-way wireless network with the electrically controlled actuator. A retrofit actuator assembly adapted to be mounted on an existing lock to control a locking mechanism of the lock, and a two-way communication device to control the retrofit actuator assembly and to receive signals from the retrofit actuator assembly indicate a state of the locking mechanism.

US2004257209 discloses an auto anti-thief system employing a Bluetooth technique. The anti-thief system includes a system core processor, a Bluetooth communication module, an anti-thief alarm control circuit, an indicator control circuit, a door lock initiator control circuit and a power voltage regulator circuit. When cooperating the present invention with the Bluetooth communication module built in the mobile phone, it can reduce the loading of carrying the remote controller for the user. Moreover, through the frequency hopping used by the wireless channel of Bluetooth, it will not be interfered with easily. Furthermore, utilizing 128 bits to protect the encoding method, the security is further increased. Therefore, the present invention breaks through the unidirectional transmission employed by the conventional remote controller. Thus, after confirming the identification between the Bluetooth mobile phone of the user and the anti-thief system through the bi-directional transmission and data transmission, the door lock can be immediately released and the user can easily and conveniently drive the car.

### SUMMARY OF THE INVENTION

According to a first aspect of the invention there is provided a lock device, comprising:

an electromechanical cylinder being retrofittable to the lock device, the electromechanical cylinder comprising:

a wireless communication device, a processing unit, an engine, and one or more mechanical pins;

the wireless communication device, configured for receiving a signal from a remote wireless-enabled communication device, the signal including identifying data;

the communication device is further configured to forward the signal to the processing unit;

the processing unit is configured for authenticating the signal and in case the signal is authenticated to send an authorizing signal to the engine;

in response to the authorization signal the engine is configured to relocate the one or more mechanical pins, such that the lock is opened or closed.

According to a second aspect of the invention there is provided an electromechanical cylinder, comprising:

a wireless communication device, a processing unit, an engine, and one or more mechanical pins;

the wireless communication device, configured for receiving a signal from a remote wireless-enabled communication device, the signal including identifying data; the communication device is further configured to forward the signal to the processing unit;

the processing unit is configured for authenticating the signal and in case the signal is authenticated to send an authorizing signal to the engine;

in response to the authorization signal the engine is configured to relocate the one or more mechanical pins, such that the lock is opened or closed; and wherein, the electromechanical cylinder is retrofittable to a mechanical lock device.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic illustration of a lock 110, in accordance with an embodiment of the invention;

FIG. 2 is a schematic illustration of an electromechanical cylinder 111, in accordance with an embodiment of the invention;

FIG. 3 is a schematic illustration of the processing unit 211, in accordance with an embodiment of the invention;

FIG. 4 is a flowchart illustrating the operation of process 400 of controlling cylinder 111, according to an embodiment of the invention;

FIG. 5 illustrates a flowchart of the operation performed by processing unit 211, in accordance with an embodiment of the invention; and

FIG. 6 is a flowchart illustrating the operations of process 600 of an emergency procedure, according to an embodiment of the invention.

### DETAILED DESCRIPTION OF EMBODIMENTS

Unless specifically stated otherwise, as apparent from the following discussions, it is appreciated that throughout the specification discussions utilizing terms such as “authenticating”, “identifying”, “communicating”, “identifying”, “storing”, “receiving”, “transmitting”, “comparing”, “decoding”, “decrypting”, “encoding”, “controlling”, or the like, refer to the action and/or processes of a computer that manipulate and/or transform data into other data, said data represented as physical, e.g. such as electronic, quantities and representing the physical objects. The term “computer” should be expansively construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices and combinations thereof.

The operations in accordance with the teachings herein may be performed by a computer specially constructed for the desired purposes or by a general purpose computer specially configured for the desired purpose by a computer program stored in a computer readable storage medium.

In addition, embodiments of the present invention are not described with reference to any particular programming language. It will be appreciated that a variety of programming languages may be used to implement the teachings of the inventions as described herein.

As used herein, the phrase “for example,” “such as” and variants thereof describing exemplary implementations of the present invention are exemplary in nature and not limiting. Reference in the specification to “one embodiment”, “an embodiment”, “some embodiments”, “another embodiment”, “other embodiments”, “certain embodiment” or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments”, “certain embodiments” or variations thereof do not necessarily refer to the same embodiment(s).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. While the invention has been shown and described with respect to particular embodiments, it is not thus limited. Numerous modifications, changes and improvements within the scope of the invention will now occur to the reader.

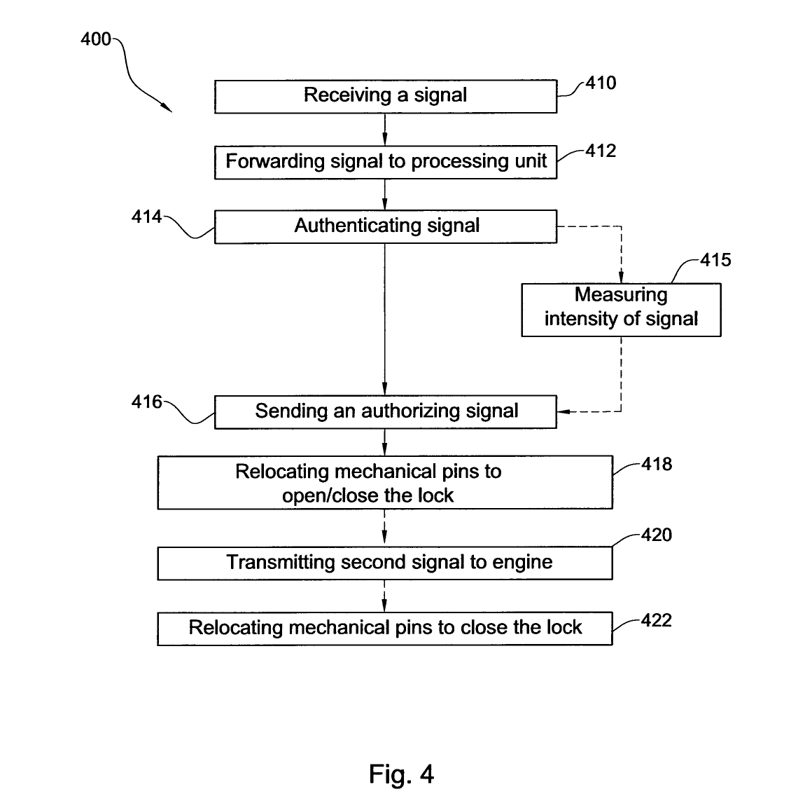

In embodiments of the invention, fewer, more and/or different stages than those shown in FIGS. 4 to 6, may be executed. In embodiments of the invention one or more stages illustrated in FIGS. 4 to 6 may be executed in a different order and/or one or more groups of stages may be executed simultaneously. FIGS. 1 to 3 illustrate a general schematic view of the architecture of the lock and/or cylinder in accordance with an embodiment of the invention. Modules in these figures can be made up of any combination of software, hardware and/or firmware that performs the functions as defined and explained herein. In other embodiments of the invention, the lock may comprise fewer, more, and/or different modules than those exemplified in the figures.

Unless defined otherwise, all technical and scientific terms used herein have the same meaning as commonly understood by one of ordinary skill in the art to which this invention belongs. Generally (although not necessarily), the nomenclature used herein described below are well known and commonly employed in the art. Unless described otherwise, conventional methods are used, such as those provided in the art and various general references.

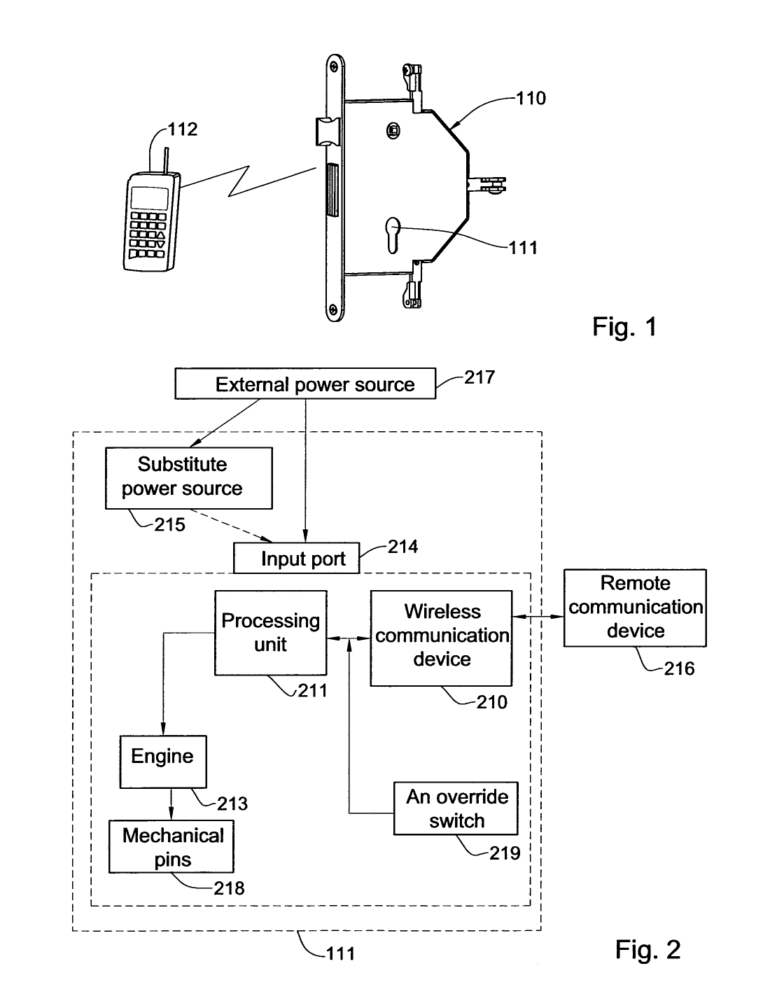

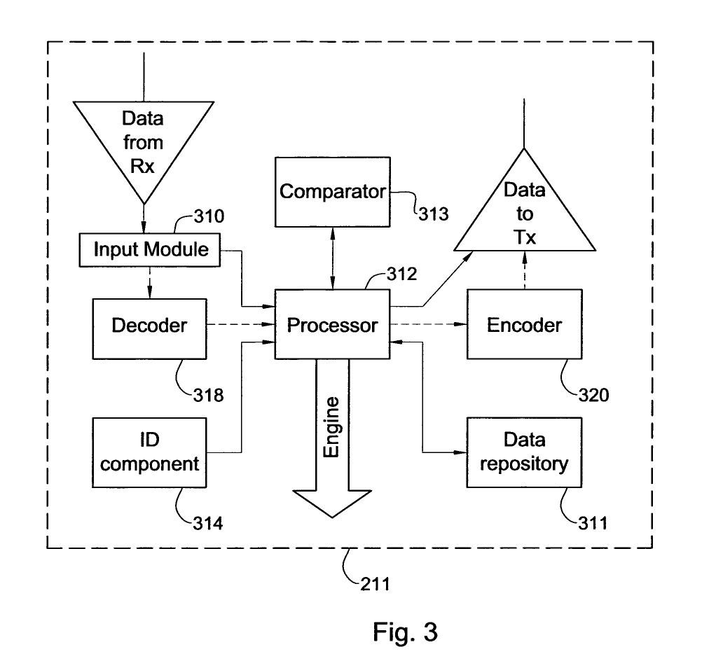

Turning now to the detailed description of the invention, FIG. 1 is a schematic illustration of a lock 110, in accordance with an embodiment of the invention. In general, lock 110 can be a lock configured to be installed within a barrier for restricting access to an area or enclosed compartment, e.g. a door, a gate or a window. Lock 110 comprises a mechanical locking device, and an electromechanical cylinder 111. In case of a need, the cylinder can be unscrewed and be replaced with another cylinder without altering the barrier itself (e.g. door, or window) or the lock comprising the cylinder. According to certain embodiments of the invention, electromechanical cylinder 111 can be designed in the shape and size of a given mechanical cylinder and configured to fit in its place within a lock. The electromechanical cylinder 111 is configured to receive a signal from a wireless-enabled communication device 112, and according to the received data, open or close the mechanical locking device. The functionality of the electromechanical lock is enabled by components, which are embedded within the electromechanical cylinder. Thus, according to the presently disclosed subject matter, by designing and constructing an electromechanical cylinder in the size and shape of a mechanical cylinder of a lock and replacing (retrofitting) the mechanical cylinder of the lock with the electromechanical cylinder, a mechanical lock can be converted into an electromechanical lock, which can be controlled from a distance by a wireless-enabled communication device 112. Electromechanical cylinder 111 is described in more details below with reference to FIG. 2 and FIG. 3.

FIG. 2 is a schematic illustration of an electromechanical cylinder 111, in accordance with an embodiment of the invention. Electromechanical cylinder 111 comprises a wireless communication device 210, a processing unit 211, an engine 213, and one or more mechanical pins 218. Electromechanical cylinder 111 may also comprise an input port 214 for receiving power from an external power source, for operating the electromechanical cylinder 111. In some embodiments, input port 214 maybe connected to a doorbell for receiving power. Electromechanical cylinder 111 further comprises a substitute power source 215 for supplying energy to the electromechanical cylinder 111 instead of or in addition to input port 214. Substitute power source 215 may be a rechargeable battery, which is charged via an external power source 217. In some embodiments, substitute power source 215 is configured as a backup power source for supplying energy to electromechanical cylinder 111 where input port 214 fails to do so.

According to certain embodiments of the invention, wireless communication device 210, is configured to receive a signal from a remote communication device 112. Remote communication device 112 may be a mobile phone device, a PDA, a personal or portable computer, or any other electronic device capable and configured for carrying out wireless communication with other devices. The communication between the communication device 210 and the remote communication device 112 may be established via any known type of wireless technology, preferably unlicensed wireless technology such as for example, Bluetooth or WiFi. Wireless communication device 210 may be any standard wireless communication device of a known type, which includes hardware and/or software for enabling wireless communication. Device 210 normally comprises an antenna and a transmitter and a receiver configured for enabling wireless communication. For example, a typical Bluetooth communication device comprises an antenna and Bluetooth integrated circuit (IC), including a transmitter and a receiver, that enables Bluetooth wireless communication over the 2.4-2.4835 GHz radio frequency (RF) band, between a device to which it is connected and other nearby Bluetooth enabled devices. According to one embodiment, the transmitter and receiver may be integrated into one transceiver unit.

According to certain embodiments, remote communication device 112 is also configured with specifically programmed utility (hardware and/or software) for communicating with communication device 210. According to certain embodiments, the appropriate software may be downloaded to remote communication device 112 from a communication network (e.g., the Internet) or otherwise obtained from any available storage medium or resource.

It should be noted, that although in the following discussion the invention is described in connection to Bluetooth technology, this technology is only one example and should not be construed as limiting.

The signal transmitted from remote communication device 112 to wireless communication device 210, includes identifying data. Identifying data may include for example data identifying remote device 112. Alternatively or additionally, identifying data may include data identifying a specific user. The received data is transmitted to processing unit 211 where it is authenticated in order to determine whether the remote communication device 112 and/or the user are authorized to control cylinder 111.

According to certain embodiments, a remote communication device is authorized and enabled to control (e.g. open and close) cylinder 111 if it is a “registered” communication device. A remote communication device 112 is considered as “registered” if e.g. its unique device ID is stored in a data repository 311 associated with processing unit 211. Similarly, a user is authorized to control (e.g. open and close) cylinder 111 if he is a “registered” user. A user is “registered” if e.g., the user's unique user ID and a corresponding password are stored in data repository 311.

According to certain embodiments, an administrator user is a user who is authorized to register communication devices and users to a given cylinder 111. Similarly, an administrator can delete or modify registered devices and users. The associated data repository 311 configured for storing the devices and users' identification data is described in more detail below with reference to FIG. 3.

According to certain embodiments, the identifying data within the signal also includes data related to a unique cylinder ID. Each cylinder of the present invention is associated with unique cylinder ID, which uniquely identifies the cylinder. For example, where a number of doors are located in close proximity, the relevant door is identified based on its unique cylinder ID. Cylinder ID may be stored in ID component 314 associated with the processing unit as explained in more detail with respect to FIG. 3.

In accordance with a certain embodiment, the signal may be transmitted as two separate subsequent signals, e.g. one including data related to the unique cylinder ID and the other including data related to the unique device ID and/or a user.

Upon receipt of a signal, it is forwarded by communication device 210, to processing unit 211, which is configured to process the data transmitted within the signal and authenticate the data. In accordance with an embodiment of the invention, in cases where the data is authenticated, an authorizing signal is transmitted by processing unit 211 to engine 213. In response to the authorizing signal, engine 213 relocates one or more mechanical pins 218, such that the mechanical lock 110 is opened or closed.

Engine 213 may be a gear engine, which can be fitted within cylinder 111. For example engine 213 may be a DC Motor with integrated gear power of 3-12V, 4 W with gear ratio of 1:100 and RPM: 3000.

In accordance with another embodiment of the invention, once the data is authenticated, processing unit 211 is configured to enter lock and track mode where it continuously tracks the signal and monitors the intensity of the input signal received by remote communication device 210. Processing unit 211 delays the transmission of the authorizing signal to the engine 213, to a point where the intensity of the signal is greater than a predefined threshold. Processing unit 211 is thus enabled to monitor the distance of the remote communication device 112 from communication device 210 and allow opening the lock only when the measured distance is less than a predefined threshold.

According to certain embodiments, processing unit 211 is further configured to lock and track the intensity of the input signal received from remote communication device, after an authorizing signal has been transmitted. Once the signal intensity is lower than a predefined low threshold, processing unit is configured to transmit a second signal to engine 213 instructing to close the lock.

In accordance with an embodiment of the present invention, the electromechanical cylinder 111 further comprises an override switch 219, which is configured to override a regular operation of the lock, and to maintain the lock either always opened or always closed. The override switch may be for example a hardware component installed from the inside of the lock or a software component installed and controlled by remote communication device 112. According to certain embodiments, override switch 219 is configured with three different positions. Each position may be indicated by a light in a different color, configured as part of override switch 219.

A first position may be referred to as an “open position”. When the switch is in the first position, the lock is open and it cannot be closed by a signal transmitted from a remote communication device.

A second position may be referred to as a “closed position”. When the switch is in a closed position, the lock is closed and it cannot be opened by a signal transmitted from a remote communication device. In a domestic households, for example, the closed position of the override switch 219 can be used e.g. during night hours.

A third position can be referred to as an “automatic lock position”, in which the lock is controlled (e.g. opened and closed), by signals received from remote communication device 112.

Turning now to a more detailed description of processing unit 211, FIG. 3 is a schematic illustration of the processing unit 211, in accordance with an embodiment of the invention. Processing unit 211 comprises an input module 310 configured for receiving a signal transmitted by communication device 210 and extract the data transmitted with the signal. As explained above, the data may include a device ID and/or a cylinder ID. Processing unit 211 further comprises a processor 312, a comparator 313 and an ID component 314 configured to store a unique cylinder ID. Processing unit may also be associated with a data-repository 311 configured for storing the devices and users' identification data.

According to a certain embodiment, processor 312 is configured to receive the data extracted by input module 310 from the received signal, and to authenticate the data, using comparator 313. According to certain embodiments, authentication of a cylinder ID is performed by comparing the received cylinder ID with data stored in ID component 314. Authentication of a device ID and/or user ID is performed by comparing the received device ID and/or user ID with the relevant data stored in data repository 311.

According to certain embodiments, once the data extracted from the signal are authenticated, processor 312 sends an authorizing signal to engine 213, which then relocates one or more mechanical pins 218, such that the mechanical lock 110 is opened or closed.

According to certain embodiments of the invention, processing unit 211 further comprises a decoder 318 for decoding an encrypted signal, if such is transmitted by remote communication device 112. An encoded signal received by input module 310 is transmitted to decoder 318 where the signal is decoded and the data is extracted from the signal. The extracted data may then be forwarded to processor 312.

According to certain embodiments of the invention, processing unit 211 further comprises an encoder 320 for encoding a signal transmitted by processor 312 back to remote communication device 112. Upon authentication of the data retrieved from a signal received from communication device 112, processor 312 transmits a signal to encoder 320, where the signal is encoded. The encoded data is then transmitted by encoder 320 back to remote communication device 112. Such communication occurs, e.g. when an administrator performs changes (addition, deletion and the like) on registered devices and/or users by sending a signal to electronic cylinder. A signal transmitted back to remote communication device 112 includes, for example, acknowledgement or denial of the operations performed by the administrator.

In accordance with an embodiment of the invention, an emergency mechanism is provided such that it avoids authentication of a device ID of a remote communication device 112, in case that usage of a registered remote communication device is impossible, e.g. if the registered remote communication device is lost, becomes inoperable, fails to communicate, etc.

In the event that a user wishes to open or close the door, and a registered remote communication device is not available, the user may replace remote communication device 112 with a second, alternative, remote communication device, which is not registered in cylinder 111. The user may utilize the alternative remote communication device to transmit a signal in order to open or close the lock. An alternative remote communication device may be any communication device configured with wireless communication, adapted for communicating with communication device 210 within cylinder 111, and having adequate storage and processing capability for running the appropriate software.

In order to control cylinder 111 using an alternative remote communication device, appropriate software is downloaded to the alternative remote communication device. The software may be downloaded from the Internet or otherwise obtained from any available storage medium or resource. According to another embodiment of the invention, the software application may already be installed on the alternative communication device.

The software installed on the alternative remote communication device enables the user to communicate via the alternative remote communication device with cylinder 111 and transmit a signal including data related to a cylinder ID, and a registered user. Data identifying a registered user may include for example a user ID and a corresponding password.

As described above, a user is registered if for example, the user's unique user ID and unique corresponding password are stored in data repository 311. Therefore, upon receipt of the data extracted by input module 310, processor 312 authenticates the data using comparator 313. According to certain embodiments, authentication of a cylinder ID is similarly performed by comparing the received cylinder ID with data stored in ID component 314. Authentication of the extracted data related to a user is performed by comparing the received user ID and password with registered users in data repository 311. Once the data extracted from the signal is authenticated, processor 312 sends an authorizing signal to engine 213, which then relocates one or more mechanical pins 218, such that the mechanical lock 110 is opened or closed.

In accordance with certain embodiments of the invention, in order to prevent the use of a registered remote communication device for controlling cylinder 111 (e.g. after it has been replaced by an alternative remote communication device), the ID component 314 integrated within the electromechanical cylinder 111 can be replaced.

FIG. 4 is a flowchart illustrating the operation of process 400 of controlling cylinder 111, according to an embodiment of the invention. In an initial stage 410, a signal is received. According to certain embodiments, the signal includes data identifying remote device 112 and unique cylinder ID. In accordance with certain embodiments, the signal may be transmitted as two separate subsequent signals, one including data identifying remote device 112 and/or user and the other including data identifying unique cylinder ID.

Upon receipt of the signal, the signal is forwarded to processing unit 211 (stage 412). In the next stage of process 400, the data within the received signal is authenticated (stage 414). According to certain embodiments of the invention, the signal received in initial stage 410 is transmitted by remote communication device 112 to communication device 210. The signal in stage 412 may be forwarded to processing unit 211, and may then be authenticated in stage 414 by processing unit 211.

In the event that the data is authenticated, an authorizing signal is transmitted to engine 213 (stage 416). In next stage 418, in response to an authorizing signal, one or more mechanical pins 218 are relocated, such that the mechanical lock 110 is opened or closed. According to an embodiment of the invention stage 418 can be performed by engine 213.

According to certain embodiments of the invention, once the data is authenticated in stage 414, the intensity of the received signal is measured in stage 415, and the transmission of the authorization signal is delayed until the intensity of the signal is greater than a predefined threshold, indicating that the device is sufficiently near the communication device 210. Once the intensity of the signal reaches the prescribed high threshold, process 400 turns to stage 416 and the authorizing signal is transmitted to engine 213. In the next stage 418, in response to an authorizing signal, one or more mechanical pins 218 are relocated, such that the mechanical lock 110 is opened or closed.

In case the lock is opened in stage 418, and once the signal intensity is lower than a predefined low threshold, according to certain embodiments, an additional stage 420 is executed. In stage 420 a second signal for closing the lock is transmitted to engine 213. In response to the second signal, one or more mechanical pins 218 are relocated, such that the mechanical lock 110 is closed (stage 422).

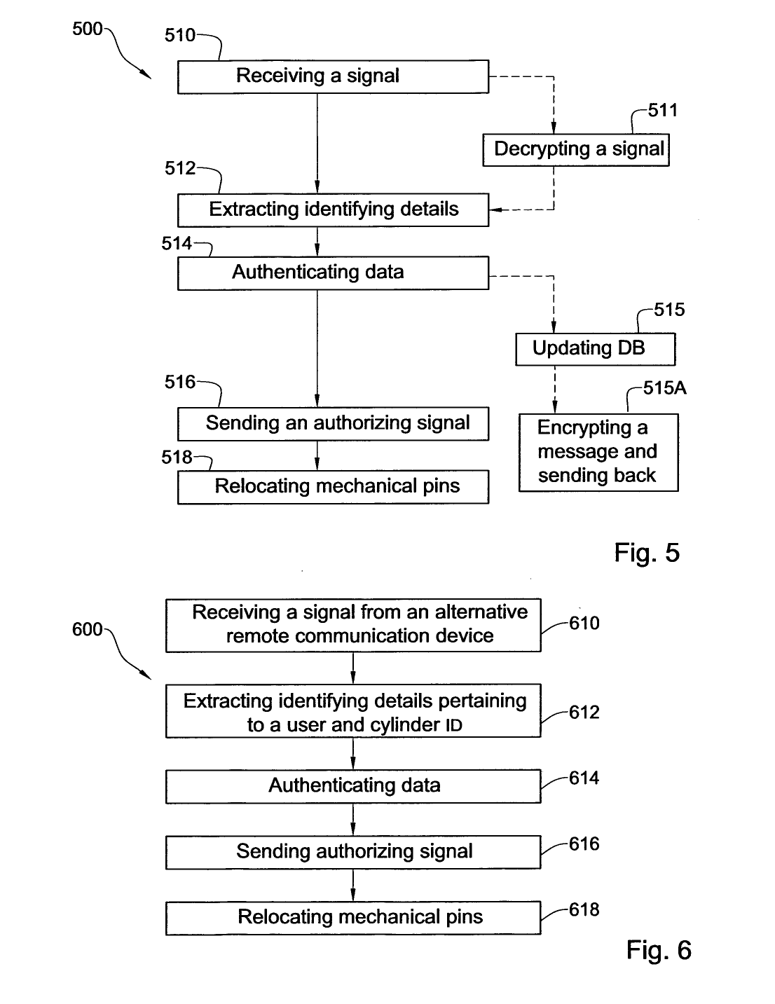

FIG. 5 illustrates a flowchart of the operations performed by processing unit 211, in accordance with an embodiment of the invention. In initial stage 510, a signal including identifying data is received. Identifying data may include for example a device ID for identifying a unique remote device 112, a registered user, or a cylinder ID. According to certain embodiments of the invention, the signal is transmitted by a remote communication device 112 and received by input module 310 located within processing unit 211. In next stage 512, data within the received signal is extracted from the signal. Once the data is extracted from the received signal, the extracted data is transmitted from input module 310 to processor 312. The process then enters stage 514, in which the identifying data is authenticated. Authentication is performed in order to determine whether the data extracted from the signal correspond to a device or a user, which are authorized to control cylinder 111. Authentication is further performed in order to determine whether the unique cylinder ID transmitted within the signal is identical to the cylinder ID stored within the ID component 314.

In next stage 516, in the event that the data is authenticated, an authorizing signal is transmitted to engine 213. In response to the authorizing signal, one or more mechanical pins 218 are relocated, such that the mechanical lock 110 is opened or closed (stage 518).

According to certain embodiments of the invention, in the event that the signal received by input module 310 is encrypted, stage 511 is executed which includes decrypting the received signal. Identifying data is then extracted from the signal in stage 512. In accordance with certain embodiments of the invention, stage 511 is performed by decoder 318.

According to another embodiment of the invention, in the event that the signal includes instructions provided by an administrator for example, to register, delete or modify a registered user and/or a device, once the data is authenticated (stage 514), process 500 proceeds to stage 515 in which data repository 311 is updated with the relevant data. Following stage 515, a message is transmitted back to remote communication device 112, indicating success, failure or providing other information with regard to the operation performed in the previous stage. According to certain embodiments in stage 515A, a signal including a message is encrypted, and sent back to remote communication device 112.

Attention is now drawn to FIG. 6, which is a flowchart illustrating the operations of process 600 of an emergency procedure, according to an embodiment of the invention. Emergency procedure enables a user to control the lock, as described above with reference to FIGS. 4 and 5, using an unregistered remote communication device. The authentication stage is performed with respect to a registered user.

In the event that a user wishes to control the lock, while a registered remote communication device is not available, an alternative remote communication device, which is not a registered communication device, is obtained. If the appropriate software for communicating with cylinder 111 is not installed on the alternative communication device, the software may be downloaded to the alternative remote communication device from the Internet or otherwise obtained from any available storage medium or resource.

In initial stage 610, a signal including identifying data is transmitted from the alternative remote communication device to communication device 210. As the original remote communication device is not available, authentication of the signal is performed based on alternative data. The signal may include identifying data related to a unique cylinder ID and to a registered user. A registered user may be identified for example by a user ID and a corresponding password.

Once the signal is received, identifying data is extracted from the signal (stage 612). In next stage 614, authenticating of the data is carried out. Authentication is performed in order to determine whether the data extracted from the signal correspond to a user, which is authorized to control cylinder 111 (i.e. a registered user). Authentication is further performed in order to determine whether the unique cylinder ID transmitted within the signal is identical to the cylinder ID stored within the ID component 314. According to certain embodiments of the invention, stage 614 may be performed by processing unit 211.

According to certain embodiments of the invention, upon authenticating the data which is extracted from the signal, an authorizing signal is transmitted to engine 213 (616), which results in relocating one or more mechanical pins 218, such that the mechanical lock 110 is opened or closed (stage 620).

1. A lock device comprising:
an electromechanical cylinder being retrofittable to said lock device, said electromechanical cylinder comprising:
a wireless communication device, a processing unit, an engine, and one or more mechanical pins;
said wireless communication device, configured to receive a signal from a remote wireless-enabled communication device, said signal including identifying data; said communication device is further configured to forward the signal to said processing unit;
said processing unit is configured to authenticate said signal and in case said signal is authenticated, to send an authorizing signal to said engine;
in response to said authorization signal said engine is configured to relocate said one or more mechanical pins, such that the lock is opened or closed.

2. An electromechanical cylinder, comprising:
a wireless communication device, a processing unit, an engine, and one or more mechanical pins;
said wireless communication device, configured to receive a signal from a remote wireless-enabled communication device, said signal including identifying data; said communication device is further configured to forward the signal to said processing unit;
said processing unit is configured to authenticate said signal and in case said signal is authenticated to send an authorizing signal to said engine;
in response to said authorization signal said engine is configured to relocate said one or more mechanical pins, such that the lock is opened or closed; and wherein, said electromechanical cylinder is retrofittable to a mechanical lock device.

3. The device according to claim 1 wherein said electromechanical cylinder further comprises an input port for supplying energy to at least said processing unit, said engine and wireless communication device.

4. The device according to claim 1, wherein said remote wireless-enabled communication device can be one of a mobile phone device, a PDA, a personal or portable computer.

5. The device according to claim 1, wherein said identifying data is indicative of at least said remote communication device and a cylinder ID.

6. The device according to claim 1, wherein said identifying data is indicative of at least cylinder ID and a registered user.

7. The device according to claim 1, wherein said signal is transmitted as two separate signals.

8. The device according to claim 1, wherein said engine is a DC Motor with integrated gear power of 3-12V, 4 W with gear ratio of 1:100 and RPM: 3000.

9. The device according to claim 1, wherein said processing unit is further configured to lock and track the intensity of the received signal and delay the transmission of the authorizing signal to a point where the intensity of the signal is greater than a predefined threshold.

10. The device according to claim 9, wherein in the event that the lock has been opened, said processing unit is further configured to lock and track the intensity of the signal received from remote communication device, and transmit a second signal for closing the lock, once intensity of the signal is lower than a predefined low threshold.

11. The device according to claim 3, wherein said electromechanical cylinder further comprises a substitute power source for supplying energy instead of or in addition to said input port.

12. The device according to claim 1, wherein said electromechanical cylinder further comprises an override switch configured for disabling control of said remote communication device.

13. The device according to claim 12 wherein said override switch is configured to maintain said lock in an open position.

14. The device according to claim 1, wherein said processing unit comprises:
an input module, a processor, an ID component configured for storing a unique cylinder ID and an associated data repository;
said input module configured for receiving and extracting said identifying data transmitted in said signal; and
said processor configured for receiving and authenticating the extracted identifying data.

15. The device according to claim 14 wherein said processing unit further comprises a decoder configured for decoding said signal in the event that the signal is encrypted.
